(19) United States
(12) Patent Application Publication
(10) Pub. No.: US 2018/0244864 A1
(43) Pub. Date: Aug. 30, 2018

(54) Method for preparing rubber protective cover of expressway guardrail

(71) Applicants: Xinqiao He, Shenzhen (CN); Shan He, Shenzhen (CN)

(72) Inventors: Xinqiao He, Shenzhen (CN); Shan He, Shenzhen (CN)

(21) Appl. No.: 15/968,753

(22) Filed: May 2, 2018

(51) Int. Cl. C08J 3/20; B29C 43/24

(52) U.S. Cl. CPC C08J 3/203; B29C 43/24; B29K 2021/00; C08J 2465/02; C08J 2321/00

(57) ABSTRACT

A method for preparing a rubber protective cover of an expressway guardrail includes steps of: (S1), preparing material, wherein the material includes high-temperature vulcanized rubber, nanometer zinc oxide, nanometer silicon dioxide and a modifier; (S2), placing the vulcanized rubber into a mixing furnace which is able to increase a temperature, and then heating to 200° C.; (S3), adding the nanometer zinc oxide, and then stirring for 10 minutes; (S4), adding the nanometer silicon dioxide, and then stirring for 5 minutes; (S5), adding the modifier, and then stirring for 30 minutes; and (S6), adding the rubber after stirring into a four-roll calender, shaping, and preparing the rubber cover having a thickness of 10-20 mm and a length of 300-600 mm. The present invention has a low cost, a corrosion resistance, an easy preparation process, a low equipment requirement and a strong operability.

### BACKGROUND OF THE PRESENT INVENTION

### Field of Invention

The present invention relates to a field of chemical industry, and more particularly to a method for preparing a rubber protective cover of an expressway guardrail.

### Description of Related Arts

The main form of the conventional expressway guardrail is semi-rigid guardrail, which is mainly formed through bending the metal material and is a continuous structure with the corrugated steel guardrail boards connecting with each other and the main column as the support. When the vehicle crashes into the semi-rigid guardrail, because of the good impact resistance and the energy absorption effect of the corrugated steel guardrail boards, the guardrail is difficult to be destroyed and meanwhile has a protection effect on the driver and passengers. The corrugated guardrail board products can be divided into the W-beam guardrail board (having a length of 4320 mm, a width of 310 mm, a beam depth of 85 mm and a board thickness of 3-4 mm) and the three-beam guardrail board (having a length of 4320 mm, a width of 506 mm, a beam depth of 85 mm and a board thickness of 3-4 mm). The facts prove that: the conventional expressway guardrail is easy to be destroyed by the vehicle; and more importantly, the spark generated during the collision process will seriously damage the vehicle and lead to the burning of the vehicle, causing the casualties. Most of the traffic accidents are caused by the destroyed expressway guardrail. Thus, on the basis of not increasing too much cost, it is necessary to add a rubber or EVA (ethylene-vinyl acetate) foaming cover having a thickness of 20-30 mm and directly arrange the cover on the surface of the corrugated boards, which has the buffer and anti-collision effects, so that the guardrail is difficult to be destroyed by the vehicle collision, the safety protection effect on the driver and passengers is increased, the spark and the burning problem due to the collision are avoided, and the safety factor is greatly increased. Therefore, it has the great practical value to develop a modified rubber or EVA material, which is beautiful, durable, weather-proof, deformation resistant and recyclable, to cover the existing guardrail surface for reinforcing the safety protective cover.

### SUMMARY OF THE PRESENT INVENTION

An object of the present invention is to provide a method for preparing a rubber protective cover of an expressway guardrail.

In order to accomplish the above object, following technical solutions are adopted.

A method for preparing a rubber protective cover of an expressway guardrail comprises steps of:

(S1), preparing material, wherein: the material comprises high-temperature vulcanized rubber, nanometer zinc oxide, nanometer silicon dioxide and a modifier in a weight ratio of (90-100):(0.05-0.2):(1-1.5):(0.1-0.8);

(S2), placing the vulcanized rubber into a mixing furnace which is able to increase a temperature, and then heating;

(S3), adding the nanometer zinc oxide, and then stirring; (S4), adding the nanometer silicon dioxide, and then stirring;

(S5), adding the modifier, and then stirring; and

(S6), adding the rubber after stirring into a four-roll calender, shaping, and preparing the rubber cover.

Preferably, the weight ratio of the vulcanized rubber, the nanometer zinc oxide, the nanometer silicon dioxide and the modifier is 98:0.1:1.3:0.6.

Preferably, in the step of S2, the vulcanized rubber is heated to 200° C.

Preferably, in the step of S3, a stirring time is 8-12 minutes.

Preferably, in the step of S4, a stirring time is 4-6 minutes.

Preferably, in the step of S5, a stirring time is 25-35 minutes.

Preferably, the rubber cover has a thickness of 10-20 mm and a length of 300-600 mm.

Preferably, the vulcanized rubber comprises components of rubber raw material, alkali-free glass fiber powders, sulfur, vulcanization accelerator, phenolic resin powders and carbon black in a weight ratio of 78:10:6:1:2:1.

Preferably, the alkali-free glass fiber powders have a particle size of 800 meshes.

Preferably, the carbon black is hard carbon black.

Compared with the existing products, the present invention has following beneficial effects.

Under the strength premise of the metal guardrail, through the buffer structure of the rubber cover, the impact kinetic energy of the vehicle is decreased, and the impact force of the vehicle when the serious traffic accident happens is also decreased, which is able to reduce the accident harm to the maximum degree. Because the rubber material is adopted, the present invention has a low cost, a corrosion resistance, an easy preparation process, a low equipment requirement and a strong operability.

### DETAILED DESCRIPTION OF THE PREFERRED EMBODIMENT

A method for preparing a rubber protective cover of an expressway guardrail comprises steps of:

(S1), preparing material, wherein: the material comprises high-temperature vulcanized rubber, nanometer zinc oxide, nanometer silicon dioxide and a modifier; and weights of the vulcanized rubber, the nanometer zinc oxide, the nanometer silicon dioxide and the modifier are respectively 98 kilograms, 0.1 kilogram, 1.3 kilograms and 0.6 kilograms;

(S2), placing the vulcanized rubber into a mixing furnace which is able to increase a temperature, and then heating to 200° C.;

(S3), adding the nanometer zinc oxide, and then stirring for 10 minutes;

(S4), adding the nanometer silicon dioxide, and then stirring for 5 minutes;

(S5), adding the modifier, and then stirring for 30 minutes; and

(S6), adding the rubber after stirring into a four-roll calender, shaping, and preparing the rubber cover having a thickness of 10-20 mm and a length of 300-600 mm.

The vulcanized rubber comprises components of: 78 kilograms of rubber raw material; 10 kilograms of alkali-free glass fiber powders; 6 kilograms of sulfur; 1 kilogram of vulcanization accelerator; 2 kilograms of phenolic resin powders; and 1 kilogram of carbon black.

What is claimed is:

1. A method for preparing a rubber protective cover of an expressway guardrail comprises steps of:
(S1), preparing material, wherein: the material comprises high-temperature vulcanized rubber, nanometer zinc oxide, nanometer silicon dioxide and a modifier in a weight ratio of (90-100):(0.05-0.2):(1-1.5):(0.1-0.8);
(S2), placing the vulcanized rubber into a mixing furnace which is able to increase a temperature, and then heating;
(S3), adding the nanometer zinc oxide, and then stirring;
(S4), adding the nanometer silicon dioxide, and then stirring;
(S5), adding the modifier, and then stirring; and
(S6), adding the rubber after stirring into a four-roll calender, shaping, and preparing the rubber cover.

2. The method for preparing the rubber protective cover of the expressway guardrail, as recited in claim 1, wherein the weight ratio of the vulcanized rubber, the nanometer zinc oxide, the nanometer silicon dioxide and the modifier is 98:0.1:1.3:0.6.

3. The method for preparing the rubber protective cover of the expressway guardrail, as recited in claim 1, wherein: in the step of S2, the vulcanized rubber is heated to 200° C.

4. The method for preparing the rubber protective cover of the expressway guardrail, as recited in claim 1, wherein: in the step of S3, a stirring time is 8-12 minutes.

5. The method for preparing the rubber protective cover of the expressway guardrail, as recited in claim 1, wherein: in the step of S4, a stirring time is 4-6 minutes.

6. The method for preparing the rubber protective cover of the expressway guardrail, as recited in claim 1, wherein: in the step of S5, a stirring time is 25-35 minutes.

7. The method for preparing the rubber protective cover of the expressway guardrail, as recited in claim 1, wherein the rubber cover has a thickness of 10-20 mm and a length of 300-600 mm.

8. The method for preparing the rubber protective cover of the expressway guardrail, as recited in claim 1, wherein: the vulcanized rubber comprises components of rubber raw material, alkali-free glass fiber powders, sulfur, vulcanization accelerator, phenolic resin powders and carbon black in a weight ratio of 78:10:6:1:2:1.

9. The method for preparing the rubber protective cover of the expressway guardrail, as recited in claim 8, wherein the alkali-free glass fiber powders have a particle size of 800 meshes.

10. The method for preparing the rubber protective cover of the expressway guardrail, as recited in claim 8, wherein the carbon black is hard carbon black.
